(19) United States
(12) Patent Application Publication
(10) Pub. No.: US 2026/0091535 A1
(43) Pub. Date: Apr. 2, 2026

(54) FIBROUS PREFORM COMPRISING A REFERENCE PATTERN

(71) Applicant: SAFRAN CERAMICS, LE HAILLAN (FR)

(72) Inventors: Marie LEFEBVRE, MOISSY-CRAMAYEL (FR); Emilie Chantal Gisèle MENDEZ, MOISSY-CRAMAYEL (FR); Jérémy Paul André BLACHIER, MOISSY-CRAMAYEL (FR); Aline PLANCKEEL, MOISSY-CRAMAYEL (FR)

(21) Appl. No.: 19/111,567

(22) PCT Filed: Sep. 4, 2023
(86) PCT No.: PCT/FR2023/051327

§ 371 Date: Mar. 13, 2025

(30) Foreign Application Priority Data
Sep. 14, 2022 (FR) FR2209231

(51) Int. Cl. B29B 11/16; D03D 13/00; D03D 15/267; D03D 15/275; D03D 25/00

(52) U.S. Cl. CPC B29B 11/16; D03D 13/004; D03D 15/267; D03D 15/275; D03D 25/005; D10B 2101/06; D10B 2101/12; D10B 2101/16; D10B 2403/033

(57) ABSTRACT

A fibrous preform for the manufacture of a part made of composite material, the fibrous preform having a three-dimensional weave includes a plurality of layers of weft yarns and a plurality of layers of warp yarns which extend in a direction perpendicular to the direction of the weft yarns, wherein each weft yarn connects warp yarns of multiple layers, the weft yarns and the warp yarns being woven according to a regular weave, the fibrous preform including, on the surface, one or more reference patterns that extend in a particular direction of the fibrous preform, a reference pattern being created by a local variation in the weave.

### TECHNICAL FIELD

The invention relates to the field of composite materials and more specifically to fibrous preforms for the manufacture of these materials or to the methods for manufacturing such preforms or such materials.

### PRIOR ART

Composite materials are of increasing technological interest and have found a wide variety of uses in recent years.

In particular, organic matrix composites (OMCs) and ceramic matrix composites (CMCs) are replacing metal parts in some portions of turbomachines. Their use contributes to optimizing aircraft performance, in particular by improving the efficiency of the turbomachine and reducing the overall mass of the turbomachine, significantly reducing emissions harmful to the environment (CO, CO₂, NOₓ, etc.).

The preparation of such materials is usually done by forming a matrix within a fibrous preform. The mechanical properties of the final part depend not only on the composition of the preform and the matrix, but also on the weave chosen for the preform, and the orientation of the fibers in the preform.

This is why the fibrous preform cannot be randomly disposed in the part manufacturing methods. In particular, it is desirable that the preform can be placed precisely in a shaper or in a densification tooling. Thus, it is possible to identify certain particular areas or directions of the preform, which ensures that the mechanical properties of the final part are those expected.

Typically, a particular direction of the preform is marked with a tracer yarn woven in that direction and which has a different appearance from the yarns on the rest of the preform. This allows for visual identification of a particular direction of the preform, which facilitates correct positioning of the preform in the tooling.

In order for the appearance of the tracer yarns to be different from the rest of the preform, the tracer yarns are of a different nature from the other yarns in the preform. For example, for a silicon carbide fibrous preform, the tracer yarns are generally chosen to be alumina yarns.

Although this solution is satisfactory overall, it has been observed that the tracer yarns, due to their different nature, do not have the same behavior as the rest of the preform during the formation of the matrix.

For example, it has been observed that the matrix does not form as well in the area around the tracer yarn as on the rest of the surface of the preform. This poor formation of the matrix near the tracer yarn results in an absence of matrix or a matrix present in low thickness around the yarn, which can lead to non-conformity of the part made of composite material in particular since an area with less matrix can lead to an area not having the desired properties.

On the one hand, there is a need for a preform whose orientation can be known so that it can be placed precisely in a shaper or densification tooling. On the other hand, there remains a need for a preform free of the disadvantages described above and associated with the use of tracer yarns in the preform.

### DISCLOSURE OF THE INVENTION

The invention aims precisely at meeting this need.

For this purpose, according to a first of its aspects, the invention proposes a fibrous preform for the manufacture of a part made of composite material, the fibrous preform having a three-dimensional weave comprising a plurality of layers of weft yarns and a plurality of layers of warp yarns which extend in a direction perpendicular to the direction of the weft yarns, wherein each weft yarn connects warp yarns of multiple layers, the weft yarns and the warp yarns being woven according to a regular weave,
the fibrous preform being characterized in that it comprises, on the surface, one or more reference patterns that extend in a particular direction of the fibrous preform, a reference pattern being created by a local variation in the weave.

The weave of the fibrous preform is very regular to meet aerodynamic needs. A point variation in the weave creates a reference pattern that breaks with the regularity of the rest of the weave.

The reference pattern makes the direction in which it extends identifiable, without the need to change the nature of the weft or warp yarns.

Thus, in such a preform, a particular direction can be identified, without requiring yarns with a nature different from the weft or warp yarns.

Furthermore, the local variation in the weave of the preform to create the reference pattern(s) does not harm the properties of the final part. In particular, the densification of the preform by the matrix is not modified by the local variation in the weave, unlike what can be observed with a tracer yarn of a different nature.

In one embodiment, the local variation in the weave is performed only on the top layer of the weave, that is to say only the top layer of the weave comprises a weave different from the rest of the weave.

The top layer of the preform is also called the skin layer or preform skin.

In one embodiment, the fibrous preform comprises a 3D weave, for example an interlock weave below the skin layer in contact with the free surface. “Three-dimensional weaving” or “3D weaving” means here a weaving method whereby at least some of the warp yarns connect weft yarns over several weft layers, such as an “interlock weave”. “Interlock weave” means here a 3D weave in which each warp layer connects several weft layers with all the yarns of the same warp layer having the same movement in the plane of the weave.

A preform according to the invention therefore allows to overcome the disadvantages related to the use of tracer yarns described above.

In one embodiment of the invention, all the weft yarns present in the skin of the preform have the same composition.

In one embodiment of the invention, all the warp yarns present in the skin of the preform have the same composition.

In one embodiment of the invention, all the weft and warp yarns present in the skin of the preform have the same composition.

In one embodiment, the particular direction identified in a preform of the invention is a weft or warp direction.

It should be noted that the terms “weft” and “warp” are conventions, which should not be interpreted in a restrictive manner. In particular, it should be noted that, throughout the text, warp and weft may be interchanged.

In one embodiment, the reference pattern is a skin yarn having a longer float than the floats of the weft or warp yarns in a regular weave.

A skin yarn is a weft or warp yarn that is present on the surface of the preform.

This embodiment is advantageous because it allows to produce a reference pattern, by changing the weave of only one skin yarn, the rest of the weave remaining identical to a regular weave. This embodiment makes it very easy to identify a weft or warp direction, without complicating the weave.

In such an embodiment, the reference pattern may be a float of a skin yarn over a length greater than or equal to the length of two and a half times the length of the elementary pattern of the weave.

The “elementary pattern of the weave”, also called “weave ratio” is understood, in the usual sense of the field, as the unit of repetition strictly necessary to reproduce the regular weave by periodicity.

For example, for a twill or satin weave the weave ratio is usually specified, and it is a 2×2 twill, satin of 4 in which the weave ratio is 4, or satin of 8 in which the weave ratio is 8.

Such a length for the float of a skin yarn defining a reference pattern allows the float of the reference pattern to be long enough to be visible to the operator, and is also distinguished from a simple unintentional weaving fault.

It should be noted that the regular weave may comprise floats of skin yarns, but over a shorter distance than the float of the reference pattern. The skin yarn making a longer float therefore disrupts the periodic repetition of the regular weave to form a reference pattern.

Such a reference pattern is easily identifiable by an optical device, particularly by a human eye.

In one embodiment, the local variation in the weave may correspond to an inversion of the weaving planes.

In this embodiment, the reference pattern is a plane of symmetry of the weave, and the particular direction is aligned along this plane of symmetry.

The regular weave comprises a repeating pattern and is produced by weaving successively planes 1, 2 . . . n, n+1, n+2. . . and until reaching the periodicity of the regular weave where one then starts again with plane 1.

The inversion of the weaving planes is obtained by weaving, from the plane n of the inversion, the same planes as before, but in decreasing order.

That is to say, we weave, from the plane n of the inversion, the planes n−1, n−2 . . . and so on up to 1 then we continue by reproducing the periodicity of the regular weave in decreasing order.

Such an inversion of the weaving planes creates on the surface of the preform a plane of symmetry of the weave, sometimes called a herringbone, which extends in a particular direction of the preform.

In one embodiment, the preform comprises in addition to an inversion of the weaving planes a modification of the skin weave compared to the regular weave allowing to make the pattern even more easily identified.

In this embodiment, the weave of the skin of the preform may be different from the rest of the preform, for example a 2×2 twill type skin, and the rest of the preform is an interlock weave.

This embodiment allows to specifically choose a skin weave in which the local variation will be even more clearly identified, thus improving the identification of the particular direction.

In one embodiment, the regular weave is selected from a satin weave, for example satin of 4, satin of 8, a twill weave, for example 2×2 twill or 4×4 twill or a plain weave, and the remainder of the preform being an interlock type weave.

In one embodiment, the reference pattern may be the superposition of a plane of symmetry and unusual floats.

This can be achieved by superimposing an inversion of the weaving planes together with the production of unusual floats.

This embodiment allows to obtain an even more unique reference pattern on the surface of the preform.

In one embodiment, the reference pattern extends across the entire width of the preform in the particular direction.

In one embodiment, the reference pattern extends across the entire width of the preform in the weft or warp direction. According to another aspect, the invention relates to a method for weaving a fibrous preform in a regular weave comprising three-dimensionally weaving a plurality of layers of weft yarns and a plurality of layers of warp yarns which extend in a direction perpendicular to the direction of the weft yarns, wherein each weft yarn connects warp yarns of multiple layers, the method being characterized in that it comprises one or more steps of locally varying the weave so as to create a reference pattern on the surface of the fibrous preform, the reference pattern extending in a particular direction of the preform.

As stated, the reference pattern is used to identify a particular direction. A one-off weaving error, therefore, cannot be considered a reference pattern, because it does not extend in a particular direction.

In one embodiment, the local variation in the weave comprises a step of producing an unusual float of a skin yarn.

An unusual float is characterized by a surface yarn that does not respect the regular structure of the weave and passes over a greater number of surface weft yarns than in the regular weave.

In one embodiment, the unusual float is a float of a length greater than or equal to the length of two and a half times the weave ratio of the regular weave.

This embodiment allows to ensure a reference pattern that is easily differentiated from an unintentional one-off weaving fault.

In one embodiment, the local variation in the weave may comprise a step of inverting the weaving planes.

This embodiment allows to artificially obtain a plane of symmetry in the weave as a reference pattern.

In one embodiment, the weave variation may be achieved by combining an inversion of the weaving planes and making unusual floats, the unusual floats being produced in the plane corresponding to the inversion of the weaving planes.

This provides an even more easily identifiable reference pattern than either one of the weave variations alone, and ensures that together the plane of symmetry and the unusual floats clearly identify the same particular direction of the preform.

According to another of its aspects, the invention relates to a method for manufacturing a part made of composite material comprising at least one step of disposing a preform as described above in a tooling during which one or more particular directions of the preform identified by the reference patterns of the preform are aligned in one or more particular directions of the tooling; and a step of forming a matrix in the preform thus disposed in the tooling to form the matrix of the part made of composite material.

The inventors have found that such a method allows to use the same tooling as those already existing and in which it is planned to dispose the preform in a particular direction, while avoiding the inhomogeneities in the formation of the matrix caused by the presence of the tracer yarns usually used to identify a particular direction of the preform.

Indeed, the reference pattern, which is obtained without variation in the nature of the skin yarns of the preform, does not disturb the formation of the matrix in the preform.

In one embodiment, the preform may comprise weft yarns that are the same as or different from the warp yarns.

In one embodiment, the preform may comprise warp yarns and weft yarns composed of carbon fibers, glass fibers, alumina fibers, silicon carbide fibers, Kevlar fibers, or a mixture of several of these fibers.

It should be understood that the method of the invention is compatible with any three-dimensional fibrous weave.

In one embodiment, the part may be a ceramic matrix part made of composite material, or an organic matrix part made of composite material.

In one embodiment, the matrix may be a resin, for example a resin comprising unsaturated polyesters or epoxides.

In one embodiment, the matrix may be alumina, mullite, silicon carbide, carbon.

In one embodiment, the step of forming the matrix may be selected from numerous impregnation methods, in particular liquid composite molding, also known as “LCM” resin transfer molding, also known as “RTM”, high-pressure resin transfer molding, also known as “HP-RTM,” and compression resin transfer molding, also known as “C-RTM.”

In such a case, the tooling may, for example, be a mold for carrying out one of the methods just described.

In another embodiment, the step of forming the matrix may be a molten metal infiltration (or MI) step.

In one embodiment, the method may further comprise a step of consolidating the preform, for example carried out by chemical vapor infiltration (or CVI) carried out before the step of forming the matrix, and the tooling may be a shaper.

In this embodiment, the method may be a method for manufacturing a part made of ceramic matrix composite material comprising at least the following steps:
a step of disposing a preform as described above in a shaper during which one or more particular directions of the preform identified by the reference patterns of the preform are aligned in one or more particular directions of the shaper;
a step of consolidating the preform carried out by chemical vapor infiltration; and
a step of infiltrating the consolidated preform by molten silicon, to form the matrix in the consolidated preform.

According to another of its aspects, the invention relates to a part made of composite material comprising a preform as described above.

For example, such a part made of composite material may be an aeronautical part, for example a turbomachine blade, a turbomachine ring or a turbomachine distributor.

The part made of composite material comprises a textile marker on its surface which is still visible.

### BRIEF DESCRIPTION OF THE DRAWINGS

FIG. 1 schematically shows a weave according to a first embodiment of the invention. FIG. 2 schematically shows a weave according to a second embodiment of the invention.

FIG. 3 schematically shows a weave according to a third embodiment of the invention.

FIG. 4 schematically shows a weave according to a fourth embodiment of the invention.

### DESCRIPTION OF THE EMBODIMENTS

The invention is now described by means of figures, present for descriptive purposes to illustrate certain embodiments of the invention and which should not be interpreted as limiting the latter.

The invention relates to a three-dimensional fibrous preform whose weave allows to directly identify a particular direction, avoiding the use of tracer yarns and the associated disadvantages described above.

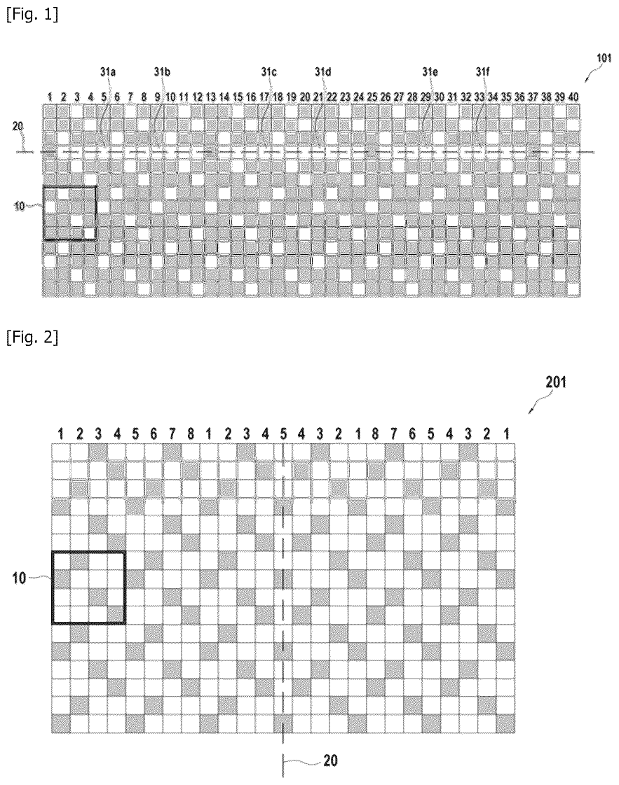

In one embodiment, the preform may be a preform of an aeronautical part, for example a turbomachine blade preform, a turbomachine ring preform or a distributor preform. FIG. 1 schematically shows the weave of a fibrous preform 101 according to a first embodiment.

Conventionally, a weave is represented by a gray and white chart in which the weft direction is represented horizontally, and the warp direction vertically.

Each square of a weave represents a crossing between a weft yarn and a warp yarn. A white dot indicates that the weft yarn passes over the warp yarn while a gray dot indicates that the warp yarn passes over the weft yarn.

The weave represented schematically by gray and white squares is visible on the surface of the preform, regardless of the nature of the yarns.

Of course, the sharpness of the weave on an actual preform is not the same as that shown schematically on the weave, but the relief created by the interweaving of the weft and warp yarns in an actual preform is easily comparable to the schematic weave.

Thus, the invention is not limited by the nature of the fibers, and the advantages described for the preforms of the invention can be obtained regardless of the nature of the weft or warp yarns.

For example, the weft and/or warp yarns may be composed of carbon fibers, glass fibers, alumina fibers, silicon carbide fibers, Kevlar fibers or a mixture of several of these fibers.

In FIG. 1, the regular weave shown is a satin of 4 the elementary pattern 10 of which is identified in FIG. 1.

The precise weave has no bearing on the successful achievement of the technical effect. Indeed, it only matters that the reference pattern is different from the rest of the weave to allow the operator to simply identify a particular direction.

The weave 101 of FIG. 1 represents 40 warp planes identified by numbers from 1 to 40, and 14 weft planes.

In FIG. 1, the particular direction 20, here aligned with the fourth weft plane, is easily identifiable because it visually differs from the rest of the weave.

In this case, the weft yarn aligned with the particular direction 20 of the fibrous preform produces unusual floats, which create reference patterns aligned with the weft direction.

It will be noted that the elementary pattern 10 comprises regular floats, in FIG. 1, floats of 3, characterized by a succession of 3 gray squares representing a weft yarn passing above 3 warp yarns in a row before being taken up under a warp yarn (white square).

In FIG. 1, an unusual float is present as a reference pattern and is formed by the absence of two consecutive crossings of the weft yarn with the warp yarns. Points 31a and 31b then 31c and 31d then 31e and 31f constitute the reference patterns in FIG. 1.

In real weave, these reference patterns will be seen as a skin yarn much longer than the other surrounding yarns and will allow the operator to locate the particular direction 20.

Such an irregular pattern in an otherwise regular weave is indeed easily identified by an optical device, and especially by the human eye.

In FIG. 1, the float of the weft yarn of the particular direction 20 is produced over a length of 11 warp planes. The ratio of the regular weave of the figure is 4, as illustrated by the elementary pattern 10 which is a square of 4 planes by 4.

In FIG. 1, the float of the weft yarn making the reference pattern is therefore greater than two and a half times the ratio of the regular weave, which ensures that the reference pattern comprises 2 differences with the elementary pattern of the regular weave, before the production of a new regular pattern. In FIG. 1, it can indeed be noted that along the particular direction, the reference pattern is created by the irregularity of 2 consecutive points 31a and 31b, then 31c and 31d, then 31e and 31f.

An unusual float length that is greater than or equal to two and a half times the regular weave ratio thus ensures that the reference pattern is different from a one-off weaving error.

Of course, when the reference pattern is an unusual float, its length must remain less than the maximum length beyond which the yarn can deform, because this would make it imprecise to determine the particular direction precisely identified by the unusual float.

For example, the maximum length of an unusual float may be less than or equal to 15 mm.

FIG. 2 shows a weave in another embodiment of the invention.

This is a satin weave of 4, the elementary pattern 10 of which is identified in FIG. 2.

In FIG. 2, the reference pattern, identifying the particular direction 20, is obtained by reversing the weaving planes.

The weave on the left of the particular direction 20 is completely regular. It is obtained by the periodic repetition of planes 1 to 8.

Note that the minimum periodicity is 4, and that planes 5 to 8 are equivalent to planes 1 to 4, but the periodicity of 8 here better illustrates the plane inversion.

From the plane numbered 5 comprising the particular direction 20, the planes of the weave are no longer repeated in ascending order 1 to 8 but in descending order 8 to 1.

The portion of the weave 201 on the right of the particular direction 20 is also a satin weave of 4, and it can be noted that the reference pattern introduced to identify the particular direction 20 has in no way modified the long-distance periodicity of the weave 201 beyond the particular direction 20.

The weave modification created by the reference pattern is extremely localized, ensuring minimal disruption to the preform.

This ensures in particular that the formation properties of the matrix are identical, despite the presence of the visual reference.

The inversion of the weaving planes allows the appearance of a reference pattern in the weave 201 which extends along the particular direction 20. Indeed, the periodicity is locally broken, and is replaced by an axial symmetry, which distinguishes the particular direction 20 from the rest of the weave 201 and makes it easily identified, in particular for a human eye.

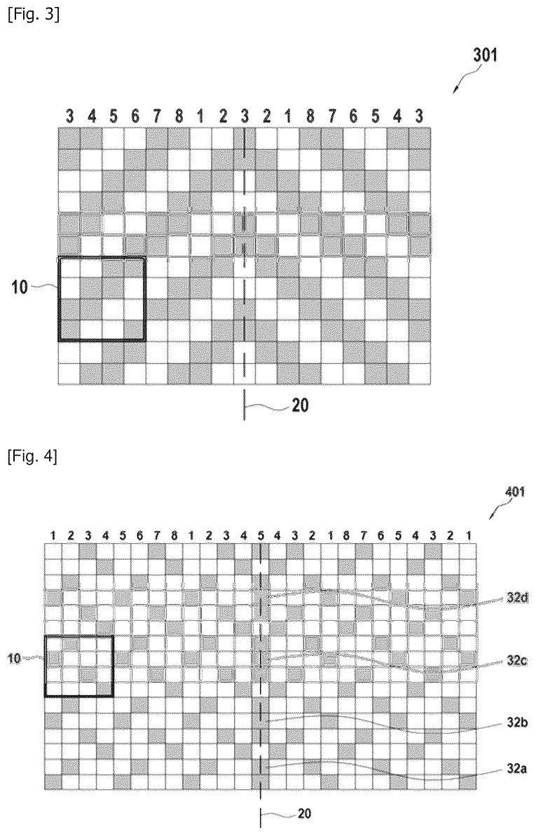

FIG. 3 shows a weave 301 in another embodiment.

This is a 2×2 twill weave, with the elementary pattern 10 identified in FIG. 3.

As in the case of FIG. 2, the local variation in the weave 301 is an inversion of the weaving planes. FIG. 3 shows the numbering of the weaves to aid understanding.

From the plane numbered 3 and comprising the particular direction, the planes of the weave are no longer repeated in ascending order 1 to 8 but in descending order 8 to 1.

The modification of the weave created by reversing planes on a 2×2 twill weave forms a reference pattern that is even more visible than for other weave types, for example the satin of 4 of FIG. 2.

FIG. 4 describes an embodiment of a weave 401 that would be obtained as for the weave 201 of FIG. 2 with a reference pattern corresponding to a plane of symmetry, obtained by inverting the weaving planes. In order to further reinforce the particular direction 20, the weave 401 further comprises unusual floats 32a, 32b, 32c and 32d, aligned with said particular direction 20.

The reference pattern for identifying the particular direction 20 is therefore the combination of the plane of symmetry and the unusual floats.

The embodiment illustrated in FIG. 4 clearly shows how the superposition of the two embodiments described above for obtaining a reference pattern can be combined to achieve a weaving pattern 401, and consequently a fibrous preform, of which a particular direction 20 can be easily identified.

This embodiment is preferred when for the chosen weave, the inversion of the weaving planes alone does not define the particular direction extremely clearly. For example, it can be noted that the plane inversion in a satin weave of 4 (FIG. 2) is not as clear as in the case of a 2×2 twill (FIG. 3). Adding to the inversion of planes the production of unusual floats then allows to identify the particular direction even more precisely.

1. A fibrous preform for the manufacture of a part made of composite material, the fibrous preform having a three-dimensional weave comprising a plurality of layers of weft yarns and a plurality of layers of warp yarns which extend in a direction perpendicular to the direction of the weft yarns, wherein each weft yarn connects warp yarns of multiple layers, the weft yarns and the warp yarns being woven according to a regular weave,
wherein the fibrous preform comprises, on a surface, one or more reference patterns that extend in a particular direction of the fibrous preform, a reference pattern being created by a local variation in the weave wherein the reference pattern is chosen amongst:
a skin yarn having a longer float than the floats of the weft or warp yarns in a pattern of the regular weave; and/or
a plane of symmetry of the weave, and the particular direction is aligned along this plane of symmetry.

2. The preform according to claim 1, wherein the particular direction is a weft or warp direction.

3. (canceled)

4. The preform according to claim 2, wherein the reference pattern is a float of a skin yarn over a length greater than or equal to two and a half times the length of the elementary pattern of the weave.

5. (canceled)

6. The preform according to claim 1, wherein the warp yarns and the weft yarns may be composed of carbon fibers, glass fibers, alumina fibers, silicon carbide fibers, Kevlar fibers or a mixture of several of these fibers.

7. A method for weaving a fibrous preform in a regular weave comprising three-dimensionally weaving a plurality of layers of weft yarns and a plurality of layers of warp yarns which extend in a direction perpendicular to the direction of the weft yarns, wherein each weft yarn connects warp yarns of multiple layers,
wherein the method further comprises one or more steps of locally varying the weave so as to create a reference pattern on the surface of the fibrous preform, the reference pattern extending in a particular direction of the preform wherein the reference pattern is chosen amongst:
a skin yarn having a longer float than the floats of the weft or warp yarns in a pattern of the regular weave; and/or
a plane of symmetry of the weave, and the particular direction is aligned along this plane of symmetry.

8. The weaving method according to claim 7, wherein the local variation in the weave comprises a step of producing an unusual float.

9. The weaving method according to claim 7, wherein the local variation in the weave comprises a step of inverting the weaving planes.

10. A method for manufacturing a part made of composite material comprising at least one step of disposing a preform according to claim 1 in a tooling during which one or more particular directions of the preform identified by the reference patterns of the preform are aligned in one or more particular directions of the tooling; and a step of forming a matrix in the preform thus disposed in a tooling.

11. A part made of composite material comprising a preform according to claim 1.
